(19) United States
(12) Patent Application Publication
(10) Pub. No.: US 2026/0221510 A1
(43) Pub. Date: Jul. 30, 2026

(54) SECONDARY BATTERY

(71) Applicant: MURATA MANUFACTURING CO., LTD., Kyoto (JP)

(72) Inventors: Satoshi UMEZU, Kyoto (JP); Hideyuki KUMITA, Kyoto (JP); Qin SI, Kyoto (JP)

(21) Appl. No.: 19/573,496

(22) Filed: Mar. 20, 2026

Related U.S. Application Data
(63) Continuation of application No. PCT/JP2024/028909, filed on Aug. 13, 2024.

(30) Foreign Application Priority Data
Sep. 22, 2023 (JP) 2023-156942

(51) Int. Cl. H01M 10/0567; H01M 4/02; H01M 4/1315; H01M 4/36; H01M 10/052; H01M 50/109

(52) U.S. Cl. CPC H01M 10/0567; H01M 4/1315; H01M 4/366; H01M 10/052; H01M 50/109; H01M 2004/027

(57) ABSTRACT

A secondary battery is provided and includes a positive electrode, a negative electrode, and an electrolytic solution. The negative electrode includes a negative electrode active material layer, and a negative electrode film provided on a surface of the negative electrode active material layer. The negative electrode film includes a fluorine compound including a carbon-fluorine bond. Based on an analysis of the negative electrode film by fluorine-19 nuclear magnetic resonance spectroscopy, two or more peaks are detectable within a range of a chemical shift of greater than or equal to −90 ppm and less than or equal to −70 ppm. A coupling constant associated with the two or more peaks is 50 Hz or less.

### CROSS REFERENCE TO RELATED APPLICATIONS

The present application is a continuation of International Patent Application No. PCT/JP2024/028909, filed on Aug. 13, 2024, which claims priority to Japanese Patent Application No. 2023-156942, filed on Sep. 22, 2023, the entire contents of which are incorporated herein by reference.

### BACKGROUND

The present technology relates to a secondary battery.

Various kinds of electronic equipment, including mobile phones, have been widely used. Such widespread use has promoted development of a secondary battery as a power source that is smaller in size and lighter in weight and allows for a higher energy density. The secondary battery includes a positive electrode, a negative electrode, and an electrolytic solution. A configuration of the secondary battery has been considered in various ways.

Specifically, a coating solution for an electrode to be used in an electrochemical device such as a lithium-ion secondary battery includes a fluorine-containing compound, a fluorine-containing ether compound, and at least one selected from the group consisting of a metal compound, a boron compound, and a silicon compound.

### SUMMARY

The present technology relates to a secondary battery.

Although consideration has been given in various ways regarding a configuration of a secondary battery, a battery characteristic of the secondary battery is not sufficient yet. Accordingly, there is room for improvement in terms of the battery characteristic of the secondary battery.

It is desirable to provide a secondary battery that makes it possible to achieve a superior battery characteristic.

A secondary battery according to an embodiment of the present technology includes a positive electrode, a negative electrode, and an electrolytic solution. The negative electrode includes a negative electrode active material layer, and a negative electrode film provided on a surface of the negative electrode active material layer. The negative electrode film includes a fluorine compound including a carbon-fluorine bond. Based on an analysis of the negative electrode film by fluorine-19 nuclear magnetic resonance spectroscopy, two or more peaks are detectable within a range of a chemical shift of greater than or equal to −90 ppm and less than or equal to −70 ppm. A coupling constant associated with the two or more peaks is 50 Hz or less.

According to the secondary battery of an embodiment of the present technology, the negative electrode film is provided on the surface of the negative electrode active material layer; the negative electrode film includes the fluorine compound including the carbon-fluorine bond; based on the analysis of the negative electrode film by the fluorine-19 nuclear magnetic resonance spectroscopy, two or more peaks are detectable within the range of the chemical shift of greater than or equal to −90 ppm and less than or equal to −70 ppm; and the coupling constant associated with the two or more peaks is 50 Hz or less. This makes it possible to achieve a superior battery characteristic.

Note that effects of the present technology are not necessarily limited to those described above and may include any of a series of effects described below in relation to the present technology.

### BRIEF DESCRIPTION OF THE FIGURES

FIG. 1 is a perspective diagram illustrating a configuration of a secondary battery according to an embodiment of the present technology.

FIG. 2 is a sectional diagram illustrating a configuration of a battery device illustrated in FIG. 1.

FIG. 3 is a plan diagram illustrating respective configurations of a positive electrode and a negative electrode illustrated in FIG. 2.

FIG. 4 is a diagram for describing a result of an analysis of a negative electrode film by fluorine-19 nuclear magnetic resonance spectroscopy.

FIG. 5 is a block diagram illustrating a configuration of an application example of the secondary battery.

FIG. 6 is a sectional diagram illustrating a configuration of a test secondary battery.

### DETAILED DESCRIPTION

The present technology are described below in further detail including with reference to the drawings according to an embodiment.

A description is given first of a secondary battery according to an embodiment of the present technology.

The secondary battery to be described here is a secondary battery in which a battery capacity is obtained through insertion and extraction of an electrode reactant, and includes a positive electrode, a negative electrode, and an electrolytic solution.

A charge capacity of the negative electrode is preferably greater than a discharge capacity of the positive electrode. In other words, an electrochemical capacity per unit area of the negative electrode is preferably greater than an electrochemical capacity per unit area of the positive electrode. This is to prevent precipitation of the electrode reactant on a surface of the negative electrode during charging.

Although not particularly limited in kind, the electrode reactant is specifically a light metal such as an alkali metal or an alkaline earth metal. Specific examples of the alkali metal include lithium, sodium, and potassium. Specific examples of the alkaline earth metal include beryllium, magnesium, and calcium.

The following description deals with an example case where the electrode reactant is lithium. A secondary battery in which the battery capacity is obtained through insertion and extraction of lithium is what is called a lithium secondary battery or a lithium-ion secondary battery. In such a secondary battery, lithium is inserted and extracted in an ionic state.

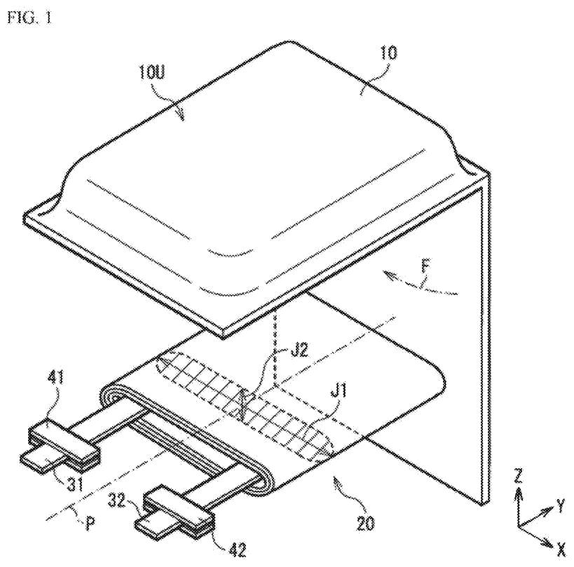

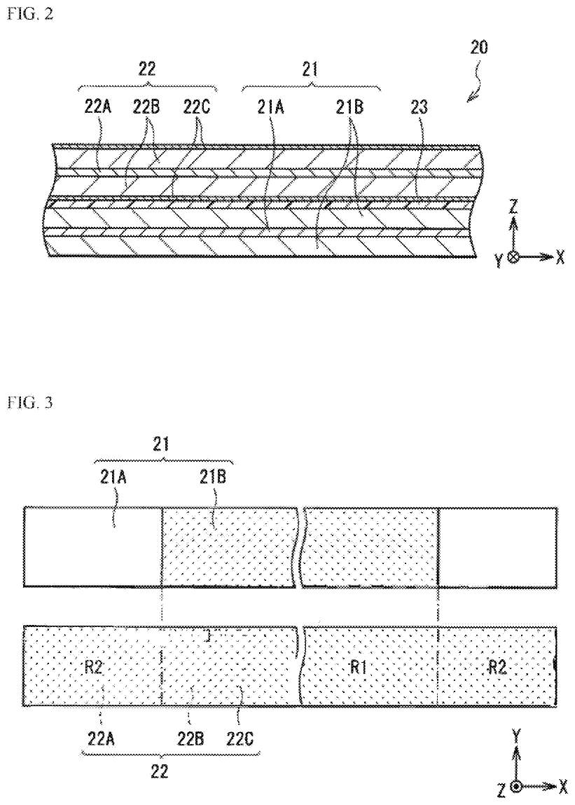

FIG. 1 illustrates a perspective configuration of the secondary battery. FIG. 2 illustrates a sectional configuration of a battery device 20 illustrated in FIG. 1. FIG. 3 illustrates a plan configuration of each of a positive electrode 21 and a negative electrode 22 illustrated in FIG. 2.

Note that FIG. 1 illustrates a state in which an outer package film 10 and the battery device 20 are separated from each other, and indicates a section of the battery device 20 along an XZ plane by a dashed line. FIG. 2 illustrates only a part of the battery device 20. FIG. 3 illustrates a state in which each of the positive electrode 21 and the negative electrode 22 is unwound.

As illustrated in FIGS. 1 and 2, the secondary battery includes the outer package film 10, the battery device 20, a positive electrode lead 31, a negative electrode lead 32, and sealing films 41 and 42.

The secondary battery described here includes the outer package film 10 as an outer package member configured to contain the battery device 20. The secondary battery illustrated in FIG. 1 is therefore a secondary battery of what is called a laminated-film type.

The outer package film 10 is an outer package member having flexibility or softness, and has a pouch-shaped structure that is sealed in a state where the battery device 20 is contained inside the outer package film 10, as illustrated in FIG. 1. The outer package film 10 thus contains the positive electrode 21, the negative electrode 22, a separator 23, and an electrolytic solution (not illustrated) that are to be described later.

Here, the outer package film 10 is a single film-shaped member and is folded toward a folding direction F. The outer package film 10 has a depression part 10U to place the battery device 20 therein. The depression part 10U is what is called a deep drawn part.

Specifically, the outer package film 10 is a three-layered laminated film including a fusion-bonding layer, a metal layer, and a surface protective layer stacked in this order from an inner side. In a state in which the outer package film 10 is folded, outer edge parts of the fusion-bonding layer opposed to each other are fusion-bonded to each other. The fusion-bonding layer includes a polymer compound such as polypropylene. The metal layer includes a metal material such as aluminum. The surface protective layer includes a polymer compound such as nylon.

Note that the outer package film 10 is not particularly limited in configuration or the number of layers, and may be single-layered or two-layered, or may include four or more layers.

The battery device 20 is contained in the outer package film 10. The battery device 20 is what is called a power generation device, and includes, as illustrated in FIGS. 1 and 2, the positive electrode 21, the negative electrode 22, the separator 23, and the electrolytic solution (not illustrated).

Here, the battery device 20 is what is called a wound electrode body. Therefore, the positive electrode 21 and the negative electrode 22 are wound about a winding axis P, and are opposed to each other with the separator 23 interposed therebetween. As illustrated in FIG. 1, the winding axis P is a virtual axis extending in a Y-axis direction.

The battery device 20 is not particularly limited in three-dimensional shape. Here, the battery device 20 has an elongated three-dimensional shape. Accordingly, a section of the battery device 20 intersecting the winding axis P, that is, the section of the battery device 20 along the XZ plane, has an elongated shape defined by a major axis J1 and a minor axis J2.

The major axis J1 is a virtual axis that extends in an X-axis direction and has a length larger than a length of the minor axis J2. The minor axis J2 is a virtual axis that extends in a Z-axis direction intersecting the X-axis direction and has the length smaller than the length of the major axis J1. Here, the battery device 20 has an elongated cylindrical three-dimensional shape. Thus, the section of the battery device 20 has an elongated, substantially elliptical shape.

The positive electrode 21 includes, as illustrated in FIG. 2, a positive electrode current collector 21A and a positive electrode active material layer 21B. Note, however, that the positive electrode current collector 21A may be omitted.

The positive electrode current collector 21A has two opposed surfaces on each of which the positive electrode active material layer 21B is to be provided. The positive electrode current collector 21A includes an electrically conductive material such as a metal material. Specific examples of the electrically conductive material include aluminum.

The positive electrode active material layer 21B includes any one or more of positive electrode active materials which lithium is to be inserted into and extracted from. Note that the positive electrode active material layer 21B may further include any one or more of other materials. Examples of the other materials include a positive electrode binder and a positive electrode conductor. A method of forming the positive electrode active material layer 21B is not particularly limited, and is specifically a method such as a coating method.

Here, the positive electrode active material layer 21B is provided on each of the two opposed surfaces of the positive electrode current collector 21A. However, the positive electrode active material layer 21B may be provided only on one of the two opposed surfaces of the positive electrode current collector 21A on a side where the positive electrode 21 is opposed to the negative electrode 22.

The positive electrode active material is not particularly limited in kind, and specific examples thereof include a lithium-containing compound. The lithium-containing compound is a compound that includes lithium and one or more transition metal elements as constituent elements. The lithium-containing compound may further include one or more other elements as one or more constituent elements. The one or more other elements are not particularly limited in kind as long as the one or more other elements are each an element other than lithium and the transition metal elements. Specifically, the one or more other elements are any one or more of elements belonging to groups 2 to 15 in the long period periodic table. The lithium-containing compound is not particularly limited in kind, and is specifically, for example, an oxide, a phosphoric acid compound, a silicic acid compound, and a boric acid compound.

Specific examples of the oxide include LiNiO₂, LiCoO₂, LiCo_{0.98}Al_{0.01}Mg_{0.01}O₂, LiNi_{0.5}Co_{0.2}Mn_{0.3}O₂, LiNi_{0.8}CO_{0.15}Al_{0.05}O₂, LiNi_{0.33}Co_{0.33}Mn_{0.33}O₂, Li_{1.2}Mn_{0.52}Co_{0.175}Ni_{0.1}O₂, Li_{1.15}(Mn_{0.65}Ni_{0.22}Co_{0.13})O₂, and LiMn₂O₄. Specific examples of the phosphoric acid compound include LiFePO₄, LiMnPO₄, LiFe_{0.5}Mn_{0.5}PO₄, and LiFe_{0.3}Mn_{0.7}PO₄.

The positive electrode binder includes any one or more of materials including, without limitation, a synthetic rubber and a polymer compound. Specific examples of the synthetic rubber include a styrene-butadiene-based rubber, a fluorine-based rubber, and ethylene propylene diene. Specific examples of the polymer compound include polyvinylidene difluoride, polyimide, and carboxymethyl cellulose.

The positive electrode conductor includes any one or more of electrically conductive materials including, without limitation, a carbon material, a metal material, and an electrically conductive polymer compound. Specific examples of the carbon material include graphite, carbon black, acetylene black, and Ketjen black.

Here, as illustrated in FIG. 3, the positive electrode active material layer 21B is provided on a part of the surface of the positive electrode current collector 21A. More specifically, the positive electrode active material layer 21B is not provided in either one end region or another end region of the positive electrode current collector 21A in a longitudinal direction, i.e., a right-left direction in FIG. 3, and is provided only in a middle region of the positive electrode current collector 21A. In FIG. 3, the positive electrode active material layer 21B is shaded.

The negative electrode 22 includes, as illustrated in FIG. 2, a negative electrode current collector 22A, a negative electrode active material layer 22B, and a negative electrode film 22C. Note, however, that the negative electrode current collector 22A may be omitted.

The negative electrode current collector 22A has two opposed surfaces on each of which the negative electrode active material layer 22B is to be provided. The negative electrode current collector 22A includes an electrically conductive material such as a metal material. Specific examples of the electrically conductive material include copper.

The negative electrode active material layer 22B includes any one or more of negative electrode active materials which lithium is to be inserted into and extracted from. Note that the negative electrode active material layer 22B may further include any one or more of other materials. Examples of the other materials include a negative electrode binder and a negative electrode conductor. A method of forming the negative electrode active material layer 22B is not particularly limited, and specifically includes any one or more of methods including, without limitation, the coating method, a vapor-phase method, a liquid-phase method, a thermal spraying method, and a firing or sintering method.

Here, the negative electrode active material layer 22B is provided on each of the two opposed surfaces of the negative electrode current collector 22A. Note, however, that the negative electrode active material layer 22B may be provided only on one of the two opposed surfaces of the negative electrode current collector 22A on a side where the negative electrode 22 is opposed to the positive electrode 21.

The negative electrode active material is not particularly limited in kind, and specific examples thereof include a carbon material and a metal-based material. One reason for this is that this allows for a high energy density.

Specific examples of the carbon material include graphitizable carbon, non-graphitizable carbon, and graphite. The graphite may be natural graphite, artificial graphite, or both.

The term “metal-based material” is a generic term for a material including, as one or more constituent elements, any one or more elements among metal elements and metalloid elements that are each able to form an alloy with lithium. Specific examples of such metal elements and metalloid elements include silicon and tin. The metal-based material may be a simple substance, an alloy, a compound, a mixture of two or more thereof, or a material including two or more phases thereof. Note that the simple substance may include any amount of impurity. Specific examples of the metal-based material include TiSi₂ and SiOₓ (0<x≤2 or 0.2<x<1.4).

Details of the negative electrode binder are similar to those of the positive electrode binder. Details of the negative electrode conductor are similar to those of the positive electrode conductor.

Note that all or a part of a surface of the metal-based material may be covered with a carbon material. Details of the carbon material are as described above.

Details of the negative electrode binder are similar to those of the positive electrode binder. Details of the negative electrode conductor are similar to those of the positive electrode conductor.

The negative electrode film 22C is provided on a surface of the negative electrode active material layer 22B, and therefore covers the surface of the negative electrode active material layer 22B.

Here, the negative electrode film 22C covers all of the surface of the negative electrode active material layer 22B. However, the negative electrode film 22C may cover only a part of the surface of the negative electrode active material layer 22B. In this case, a plurality of negative electrode films 22C may cover the surface of the negative electrode active material layer 22B at respective locations separate from each other.

Specifically, the negative electrode film 22C includes any one or more of fluorine compounds, and includes a carbon-fluorine bond. The carbon-fluorine bond is a covalent bond between carbon and fluorine. The number of carbon-fluorine bonds is not particularly limited.

Regarding physical properties of the negative electrode 22, more specifically, regarding physical properties of the negative electrode film 22C present at an outermost surface of the negative electrode 22, a predetermined physical property condition is satisfied. The physical properties of the negative electrode film 22C will be described in detail later.

Note that the fluorine compound is not particularly limited in configuration, as long as the predetermined physical property condition is satisfied regarding the physical properties of the negative electrode film 22C, as described above. The configuration of the fluorine compound will also be described in detail later.

Here, as illustrated in FIG. 3, the negative electrode active material layer 22B is provided on all of the surface of the negative electrode current collector 22A. More specifically, the negative electrode active material layer 22B is provided in the entire region of the negative electrode current collector 22A in the longitudinal direction (the right-left direction in FIG. 3). Accordingly, the negative electrode film 22C is provided in the entire region of the negative electrode active material layer 22B in the longitudinal direction, as with the negative electrode active material layer 22B. In FIG. 3, the negative electrode film 22C is shaded.

The negative electrode 22 includes one opposed part R1 and two non-opposed parts R2. The opposed part R1 is a part in which the negative electrode active material layer 22B is opposed to the positive electrode active material layer 21B, and is thus to be substantially involved in charging and discharging reactions. In contrast, the non-opposed parts R2 are each a part in which the negative electrode active material layer 22B is not opposed to the positive electrode active material layer 21B, and are thus not to be substantially involved in the charging and discharging reactions. Here, the opposed part R1 is disposed between the two non-opposed parts R2.

The separator 23 is an insulating porous film interposed between the positive electrode 21 and the negative electrode 22 as illustrated in FIG. 2, and allows lithium to pass therethrough in an ionic state while preventing a short circuit to be caused by contact between the positive electrode 21 and the negative electrode 22. The separator 23 includes a polymer compound such as polyethylene.

The electrolytic solution is a liquid electrolyte. The positive electrode 21, the negative electrode 22, and the separator 23 are each impregnated with the electrolytic solution. The electrolytic solution includes a solvent and an electrolyte salt.

The solvent includes any one or more of non-aqueous solvents (organic solvents), and the electrolytic solution including the one or more non-aqueous solvents is what is called a non-aqueous electrolytic solution.

The non-aqueous solvent is, for example, an ester or an ether, more specifically, a carbonic-acid-ester-based compound, a carboxylic-acid-ester-based compound, or a lactone-based compound, for example. One reason why the solvent includes the non-aqueous solvent(s) is that a dissociation property of the electrolyte salt and mobility of ions improve.

The carbonic-acid-ester-based compound is a cyclic carbonic acid ester or a chain carbonic acid ester. Specific examples of the cyclic carbonic acid ester include ethylene carbonate and propylene carbonate, and specific examples of the chain carbonic acid ester include dimethyl carbonate, diethyl carbonate, and ethyl methyl carbonate.

The carboxylic-acid-ester-based compound is, for example, a chain carboxylic acid ester.

Specific examples of the chain carboxylic acid ester include ethyl acetate, ethyl propionate, propyl propionate, and ethyl trimethylacetate.

The lactone-based compound is, for example, a lactone. Specific examples of the lactone include γ-butyrolactone and γ-valerolactone.

Note that the ether may be, for example, 1,2-dimethoxyethane, tetrahydrofuran, 1,3-dioxolane, or 1,4-dioxane.

Examples of the non-aqueous solvent further include an unsaturated cyclic carbonic acid ester, a fluorinated cyclic carbonic acid ester, a sulfonic acid ester, a phosphoric acid ester, an acid anhydride, and an isocyanate compound. One reason for this is that this improves electrochemical stability of the electrolytic solution.

Specific examples of the unsaturated cyclic carbonic acid ester include vinylene carbonate, vinyl ethylene carbonate, and methylene ethylene carbonate. Specific examples of the fluorinated cyclic carbonic acid ester include monofluoroethylene carbonate and difluoroethylene carbonate. Specific examples of the sulfonic acid ester include propane sultone and propene sultone. Specific examples of the phosphoric acid ester include trimethyl phosphate and triethyl phosphate. Specific examples of the acid anhydride include succinic anhydride, 1,2-ethanedisulfonic anhydride, and 2-sulfobenzoic anhydride. Specific examples of the isocyanate compound include hexamethylene diisocyanate.

In particular, the non-aqueous solvent preferably includes any one or more of nitrile compounds. One reason for this is that this suppresses a decomposition reaction of the electrolytic solution upon charging and discharging.

The term “nitrile compound” is a generic term for a compound including one or more cyano groups (—CN). Specific examples of the nitrile compound including one cyano group include acetonitrile. Specific examples of the nitrile compound including two cyano groups include succinonitrile, glutaronitrile, adiponitrile, 3,3′-(ethylenedioxy)dipropionitrile, 1,2,3-propanetricarbonitrile, 1,3,5-pentanetricarbonitrile, 1,3,4-hexanetricarbonitrile, 1,3,6-hexanetricarbonitrile, 1,3,5-cyclohexanetricarbonitrile, and 1,3,5-benzenetricarbonitrile.

In particular, the nitrile compound is preferably the compound including two cyano groups. One reason for this is that this further suppresses the decomposition reaction of the electrolytic solution upon charging and discharging.

The electrolyte salt includes any one or more of light metal salts including, without limitation, a lithium salt.

Specific examples of the lithium salt include lithium hexafluorophosphate (LiPF₆), lithium tetrafluoroborate (LiBF₄), lithium trifluoromethanesulfonate (LiCF₃SO₃), lithium bis(fluorosulfonyl)imide (LiN(FSO₂)₂), lithium bis(trifluoromethanesulfonyl)imide (LiN(CF₃SO₂)₂), lithium tris(trifluoromethanesulfonyl) methide (LiC(CF₃SO₂)₃), lithium bis(oxalato)borate (LiB(C₂O₄)₂), lithium monofluorophosphate (Li₂PFO₃), and lithium difluorophosphate (LiPF₂O₂). One reason for this is that this allows for a high battery capacity.

A content of the electrolyte salt is not particularly limited, and is specifically within a range from 0.3 mol/kg to 3.0 mol/kg both inclusive with respect to the solvent. One reason for this is that this allows for high ion conductivity.

As illustrated in FIGS. 1 and 2, the positive electrode lead 31 is a positive electrode terminal coupled to the positive electrode current collector 21A of the positive electrode 21, and is led to an outside of the outer package film 10. The positive electrode lead 31 includes an electrically conductive material such as a metal material. Specific examples of the electrically conductive material include aluminum. The positive electrode lead 31 is not particularly limited in shape, and specifically has any of shapes including, without limitation, a thin plate shape and a meshed shape.

As illustrated in FIGS. 1 and 2, the negative electrode lead 32 is a negative electrode terminal coupled to the negative electrode current collector 22A of the negative electrode 22, and is led to the outside of the outer package film 10. The negative electrode lead 32 includes an electrically conductive material such as a metal material. Specific examples of the electrically conductive material include copper. Details of a direction in which the negative electrode lead 32 is led are similar to those of the direction in which the positive electrode lead 31 is led. Details of a shape of the negative electrode lead 32 are similar to those of the shape of the positive electrode lead 31.

As illustrated in FIG. 1, the sealing film 41 is interposed between the outer package film 10 and the positive electrode lead 31. The sealing film 42 is interposed between the outer package film 10 and the negative electrode lead 32. Note that the sealing film 41, the sealing film 42, or both may be omitted.

The sealing film 41 is a sealing member that prevents entry of, for example, outside air into the outer package film 10. The sealing film 41 includes a polymer compound such as a polyolefin that has adherence to the positive electrode lead 31. Specific examples of the polyolefin include polypropylene.

The sealing film 42 has a configuration similar to the configuration of the sealing film 41 except that the sealing film 42 is a sealing member that has adherence to the negative electrode lead 32. More specifically, the sealing film 42 includes a polymer compound such as a polyolefin that has adherence to the negative electrode lead 32.

Next, a description is given of the physical properties of the negative electrode film 22C.

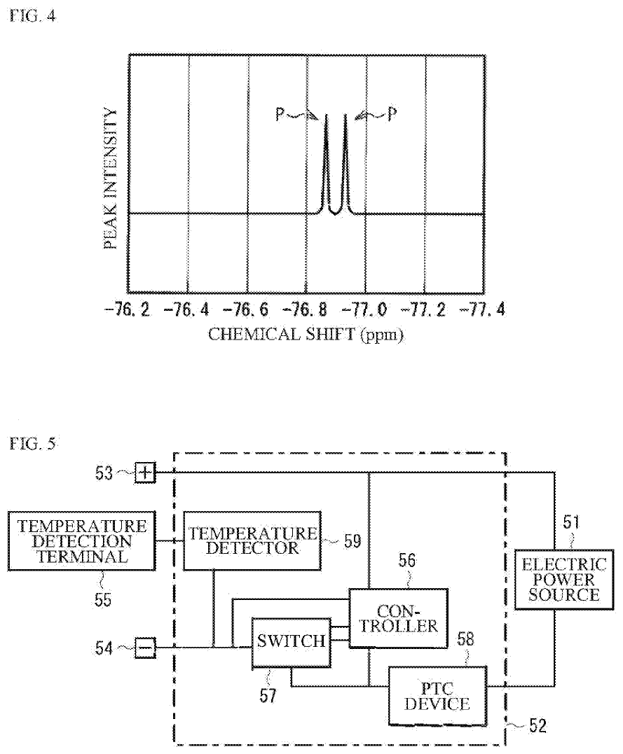

To describe a result of an analysis of the negative electrode film 22C by fluorine-19 nuclear magnetic resonance spectroscopy (¹⁹F NMR), FIG. 4 illustrates an example of the result of the analysis of the negative electrode film 22C. In FIG. 4, a horizontal axis represents a chemical shift (ppm), and a vertical axis represents peak intensity (in arbitrary units).

The negative electrode film 22C includes the fluorine compound, as described above. Therefore, the predetermined physical property condition is satisfied regarding the physical properties of the negative electrode film 22C.

Specifically, the negative electrode 22 is analyzed by the ¹⁹F NMR. In this case, the negative electrode film 22C present at the outermost surface of the negative electrode 22 is analyzed, and the result of the analysis in FIG. 4 is thus obtained.

In relation to the result of the analysis of the negative electrode film 22C by the ¹⁹F NMR, two physical property conditions described below are satisfied.

Firstly, two or more peaks P are detectable within a range of the chemical shift from −90 ppm to −70 ppm both inclusive. FIG. 4 illustrates a case where two peaks P are detected within the range of the chemical shift from −90 ppm to −70 ppm both inclusive.

The detected peaks P are derived from fluorine included in the fluorine compound as a constituent element, more specifically, from the carbon-fluorine bond. The number of the peaks P varies depending on the configuration of the fluorine compound.

Secondly, a coupling constant associated with the two or more peaks P is 50 Hz or less. The coupling constant is what is called a spin-spin coupling constant or a J-value. The coupling constant is calculated based on the following calculation expression: coupling constant (Hz)=measured frequency F (Hz)×chemical shift difference Δδ (ppm).

Note that the chemical shift difference Δδ is a value resulting from subtracting a chemical shift δ2 (ppm) corresponding to one peak P from a chemical shift δ1 (ppm) corresponding to another peak P. Therefore, the chemical shift difference Δδ is calculated based on the following calculation expression: chemical shift difference Δδ=chemical shift δ1−chemical shift δ2.

When two peaks P are detected as illustrated in FIG. 4, the coupling constant is calculated based on the chemical shift difference Δδ associated with the two peaks P.

Although not specifically illustrated here, when three or more peaks P are detected, the coupling constant is calculated based on the largest value of a plurality of chemical shift differences Δδ associated with the three or more peaks P. For example, when three peaks P are detected, two chemical shift differences Δδ are obtained. Thus, the coupling constant is calculated based on a larger value of the two chemical shift differences Δδ.

One reason why the two physical property conditions are satisfied regarding the physical properties of the negative electrode film 22C is that this brings the negative electrode film 22C including the fluorine compound into an electrochemically appropriate state.

This allows the surface of the negative electrode active material layer 22B including the negative electrode active material, which is highly reactive, to be appropriately protected by the negative electrode film 22C, and thus suppresses the decomposition reaction of the electrolytic solution on the surface of the negative electrode 22. In addition, this prevents a decomposed material such as the solvent or the electrolyte salt from easily depositing on the surface of the negative electrode 22 upon charging and discharging, and thus prevents an electric resistance of the negative electrode 22 from easily increasing.

Accordingly, because an increase in the electric resistance of the negative electrode 22 is suppressed and the decomposition reaction of the electrolytic solution is also suppressed upon charging and discharging, the discharge capacity is prevented from easily decreasing even upon repeated charging and discharging.

A procedure for analyzing the negative electrode film 22C by the ¹⁹F NMR is as described below.

As an analyzer, for example, a nuclear magnetic resonance spectrometer INSTRUM Advance NEO 500 available from Bruker corporation is used. Analysis conditions are set as follows: probe head=5 mmφ iProbeTBO (PI HR-TBO500-S1-BBF/H/F/D-5.0-Z FP); temperature controller=SmartCooler BCU II; magnetic field intensity=11.74736; T, temperature=25° C.; nucleus being observed=¹⁹F; observation frequency=470.5453180 MHz; observation pulse=25.0 μm; acquisition time=3.59424 s; relaxation delay=20 s; and number of accumulations=256. Lithium bis(trifluoromethane sulfonyl)imide (LiTFSI) is used as a reference material to set a chemical shift value to −80 ppm.

To analyze the negative electrode film 22C, first, the secondary battery is disassembled to thereby take out the negative electrode 22. Thereafter, the negative electrode 22 is washed with a solvent for washing, to remove the electrolytic solution attached to the negative electrode 22. Although not particularly limited in kind, the solvent for washing specifically includes any one or more of organic solvents including, without limitation, dimethyl carbonate. Thereafter, the negative electrode 22 that has been washed is dried, following which a solid electrolyte interface (SEI) film is extracted using a solvent for extraction. Although not particularly limited in kind, the solvent for extraction specifically includes any one or more of deuterated solvents including, without limitation, heavy water, deuterated acetone, and deuterated DMSO. In this case, lithium bis(trifluoromethane sulfonyl)imide (LiTFSI) is added to the solvent for extraction to use lithium bis(trifluoromethane sulfonyl)imide (LiTFSI) as the reference material in the analysis by the nuclear magnetic resonance spectrometer (¹⁹F NMR). Lastly, the surface of the negative electrode 22, i.e., the negative electrode film 22C, is analyzed using the nuclear magnetic resonance spectrometer (¹⁹F NMR).

Note that to analyze the negative electrode film 22C, it is preferable to analyze the negative electrode film 22C in the non-opposed part R2 rather than the opposed part R1 illustrated in FIG. 3. One reason for this is that, because the non-opposed part R2 is not substantially involved in the charging and discharging reactions as described above, it is possible to accurately check, with high reproducibility, the physical properties of the negative electrode film 22C in the non-opposed part R2, independently of charging and discharging history such as whether the secondary battery has been charged and discharged, or the number of times of charging and discharging.

The fluorine compound is not particularly limited in configuration as described above, as long as the two physical property conditions are satisfied regarding the physical properties of the negative electrode film 22C.

Specifically, the negative electrode film 22C preferably includes any one or more of fluorinated alkoxides each represented by Formula (1). One reason for this is that this allows the two physical property conditions to be easily satisfied regarding the physical properties of the negative electrode film 22C, and thus sufficiently suppresses an increase in the electric resistance of the negative electrode 22 and sufficiently suppresses the decomposition reaction of the electrolytic solution during charging and discharging.

$$R 1 R 2 R 3 COLi \qquad ( 1 )$$

where:
each of R1, R2, and R3 is one of a hydrogen group, an alkyl group, or a fluorinated alkyl group;
and
at least one of R1, R2, or R3 is the fluorinated alkyl group.

Each of R1 to R3 is not particularly limited as long as each of R1 to R3 is one of a hydrogen group, an alkyl group, or a fluorinated alkyl group, as described above. Note that R1 to R3 may be the same as each other in kind, or may be different from each other in kind. It goes without saying that only any two of R1 to R3 may be the same as each other in kind.

The alkyl group may have a straight-chain structure, or may have a branched structure having one or more side chains. Carbon number of the alkyl group is not particularly limited, and is preferably within a range from 1 to 4 both inclusive in particular. One reason for this is that this improves solubility and compatibility of the fluorinated alkoxide, and thus allows the negative electrode film 22C including the fluorinated alkoxide to be easily formed on the surface of the negative electrode active material layer 22B.

Specific examples of the alkyl group include a methyl group, an ethyl group, a propyl group, and a butyl group. Note that the alkyl group is not limited to a straight-chain structure and may have a branched structure, as described above. Therefore, for example, the propyl group may be an n-propyl group or an isopropyl group. For example, the butyl group may be an n-butyl group, a sec-butyl group, or a tert-butyl group.

The fluorinated alkyl group is a group corresponding to an alkyl group in which one or more hydrogen groups are substituted with one or more fluorine groups. Details, including the configuration and the carbon number, of the alkyl group are as described above.

Specific examples of the fluorinated alkyl group include a perfluoromethyl group, a perfluoroethyl group, a perfluoropropyl group, and a perfluorobutyl group. Note that specific examples of the fluorinated alkyl group are not limited to perfluoro groups, and may therefore include a monofluoromethyl group, a monofluoroethyl group, a monofluoropropyl group, a monofluorobutyl group, a trifluoroethyl group, and a hexafluoroisopropyl group.

Note that one or more of R1, R2, or R3 are each the fluorinated alkyl group, as described above, because the fluorinated alkoxide includes one or more atoms of fluorine as a constituent element. Therefore, a compound in which each of R1, R2, and R3 is a hydrogen group or an alkyl group is excluded from the fluorinated alkoxide described here.

In particular, two of R1, R2, or R3 are each preferably the fluorinated alkyl group. One reason for this is that this allows the two physical property conditions to be more easily satisfied regarding the physical properties of the negative electrode film 22C, and thus further suppresses an increase in the electric resistance of the negative electrode 22 and further suppresses the decomposition reaction of the electrolytic solution during charging and discharging.

Note that although not particularly limited, carbon number of the fluorinated alkoxide is preferably within a range from 3 to 5 both inclusive, in particular. One reason for this is that this allows the two physical property conditions to be more easily satisfied regarding the physical properties of the negative electrode film 22C, and thus further suppresses an increase in the electric resistance of the negative electrode 22 and further suppresses the decomposition reaction of the electrolytic solution during charging and discharging.

Specific examples of the fluorinated alkoxide include (CF₃)₂HCOLi, (CF₃)₂FCOLi, (CF₃CH₂)₂HCOLi, and (CF₃CF₂)₂HCOLi.

The secondary battery operates as described below.

Upon charging, in the battery device 20, lithium is extracted from the positive electrode 21 in an ionic state, and the extracted lithium is inserted into the negative electrode 22 via the electrolytic solution in the ionic state. Upon discharging, in the battery device 20, lithium is extracted from the negative electrode 22 in the ionic state, and the extracted lithium is inserted into the positive electrode 21 via the electrolytic solution in the ionic state.

To manufacture the secondary battery, the positive electrode 21 and the negative electrode 22 are each fabricated, and the electrolytic solution is prepared, following which the secondary battery is assembled using the positive electrode 21, the negative electrode 22, and the electrolytic solution, and the assembled secondary battery is subjected to a stabilization process, in accordance with an example procedure to be described below.

First, the positive electrode active material, the positive electrode binder, and the positive electrode conductor are mixed with each other to thereby obtain a positive electrode mixture. Thereafter, the positive electrode mixture is put into a solvent to thereby prepare a positive electrode mixture slurry in paste form. The solvent may be an aqueous solvent, or may be an organic solvent.

Thereafter, the positive electrode mixture slurry is applied on the two opposed surfaces of the positive electrode current collector 21A to thereby form the positive electrode active material layers 21B. Lastly, the positive electrode active material layers 21B are compression-molded using a compression apparatus such as a roll pressing machine. In this case, the positive electrode active material layers 21B may be heated. The positive electrode active material layers 21B may be compression-molded multiple times.

The positive electrode active material layers 21B are thus formed on the two respective opposed surfaces of the positive electrode current collector 21A. As a result, the positive electrode 21 is fabricated.

First, the negative electrode active material, the negative electrode binder, and the negative electrode conductor are mixed with each other to thereby obtain a negative electrode mixture. Thereafter, the negative electrode mixture is put into a solvent to thereby prepare a negative electrode mixture slurry in paste form. Details of the solvent are similar to those described in relation to the fabrication of the positive electrode 21. Thereafter, the negative electrode mixture slurry is applied on the two opposed surfaces of the negative electrode current collector 22A to thereby form the negative electrode active material layers 22B.

Thereafter, the fluorine compound is put into a solvent to thereby prepare a coating solution. The solvent may be an aqueous solvent, or may be an organic solvent. The coating solution is a preparation solution for forming the negative electrode film 22C, and may include any other material such as a binder on an as-needed basis. The binder includes any one or more of polymer compounds including, without limitation, polyvinylidene difluoride.

Thereafter, the coating solution is applied on the surface of each of the negative electrode active material layers 22B to thereby form the negative electrode film 22C.

Lastly, the negative electrode active material layers 22B and the negative electrode films 22C are compression-molded using a compression apparatus such as the roll pressing machine. In this case, the negative electrode active material layers 22B and the negative electrode films 22C may be heated. The negative electrode active material layers 22B and the negative electrode films 22C may be compression-molded multiple times.

The negative electrode active material layers 22B and the negative electrode films 22C are thus formed on the respective two opposed surfaces of the negative electrode current collector 22A. As a result, the negative electrode 22 is fabricated.

The electrolyte salt is put into the solvent. The electrolyte salt is thereby dispersed or dissolved in the solvent. Thus, the electrolytic solution is prepared.

First, the positive electrode lead 31 is coupled to the positive electrode current collector 21A of the positive electrode 21 by a joining method such as a welding method, and the negative electrode lead 32 is coupled to the negative electrode current collector 22A of the negative electrode 22 by a joining method such as the welding method.

Thereafter, the positive electrode 21 and the negative electrode 22 are stacked on each other with the separator 23 interposed therebetween, following which the stack of the positive electrode 21, the negative electrode 22, and the separator 23 is wound to thereby fabricate a wound body (not illustrated). The wound body has a configuration similar to the configuration of the battery device 20 except that the positive electrode 21, the negative electrode 22, and the separator 23 are each not impregnated with the electrolytic solution and the wound body has a cylindrical shape. Thereafter, the wound body is pressed using a compression apparatus such as the pressing machine to thereby shape the wound body into an elongated shape.

Thereafter, the wound body is placed in the depression part 10U, following which the outer package film 10 (the fusion-bonding layer/the metal layer/the surface protective layer) is folded to thereby cause parts of the outer package film 10 to be opposed to each other. Thereafter, outer edge parts of two sides of the fusion-bonding layer opposed to each other are bonded to each other by a bonding method such as a thermal-fusion-bonding method to thereby allow the wound body to be contained in the outer package film 10 having a pouch shape.

Lastly, the electrolytic solution is injected into the outer package film 10 having the pouch shape, following which outer edge parts of the remaining one side of the fusion-bonding layer opposed to each other are bonded to each other by a bonding method such as the thermal-fusion-bonding method. In this case, the sealing film 41 is interposed between the outer package film 10 and the positive electrode lead 31, and the sealing film 42 is interposed between the outer package film 10 and the negative electrode lead 32.

The wound body is thereby impregnated with the electrolytic solution, and the battery device 20 that is a wound electrode body is thus fabricated. Accordingly, the battery device 20 is sealed in the outer package film 10 having the pouch shape. The secondary battery is thus assembled.

The assembled secondary battery is charged and discharged. Various conditions including, for example, an environment temperature, the number of times of charging and discharging (the number of cycles), and charging and discharging conditions may be set as desired. As a result, a film is formed on the surface of each of the positive electrode 21 and the negative electrode 22, which brings the battery device 20 into an electrochemically stable state. The secondary battery is thus completed.

According to the secondary battery, the negative electrode film 22C is provided on the surface of the negative electrode active material layer 22B, the negative electrode film 22C includes the fluorine compound, and the two physical property conditions are satisfied regarding the physical properties of the negative electrode film 22C.

Specifically, based on the analysis of the negative electrode film 22C by the ¹⁹F NMR, two or more peaks P are detectable within the range of the chemical shift from −90 ppm to −70 ppm both inclusive, and the coupling constant associated with the two or more peaks P is 50 Hz or less.

In this case, the negative electrode film 22C including the fluorine compound is in an electrochemically appropriate state, as described above. This allows the negative electrode active material layer 22B including the negative electrode active material, which is highly reactive, to be appropriately protected by the negative electrode film 22C, and thus suppresses the decomposition reaction of the electrolytic solution on the surface of the negative electrode 22. In addition, this prevents the decomposed material such as the solvent or the electrolyte salt from easily depositing on the surface of the negative electrode 22 upon charging and discharging, and thus prevents the electric resistance of the negative electrode 22 from easily increasing.

Accordingly, because an increase in the electric resistance of the negative electrode 22 is suppressed and the decomposition reaction of the electrolytic solution is suppressed upon charging and discharging, the discharge capacity is prevented from easily decreasing even upon repeated charging and discharging. Accordingly, it is possible to achieve a superior battery characteristic.

In particular, the negative electrode film 22C may include the fluorinated alkoxide represented by Formula (1). This allows the two physical property conditions to be easily satisfied regarding the physical properties of the negative electrode film 22C. This sufficiently suppresses an increase in the electric resistance of the negative electrode 22 and sufficiently suppresses the decomposition reaction of the electrolytic solution during charging and discharging. Accordingly, it is possible to achieve higher effects.

In this case, two of R1, R2, or R3 in Formula (1) may each be the fluorinated alkyl group. This allows the two physical property conditions to be more easily satisfied regarding the physical properties of the negative electrode film 22C. Accordingly, it is possible to achieve higher effects. Further, the carbon number of the fluorinated alkoxide may be within the range from 3 to 5 both inclusive. This allows the two physical property conditions to be more easily satisfied regarding the physical properties of the negative electrode film 22C. Accordingly, it is possible to achieve higher effects.

Further, the electrolytic solution may include the nitrile compound. This suppresses the decomposition reaction of the electrolytic solution upon charging and discharging. Accordingly, it is possible to achieve higher effects.

Further, the secondary battery may include a lithium secondary battery. This makes it possible to stably obtain a sufficient battery capacity through the insertion and extraction of lithium. Accordingly, it is possible to achieve higher effects.

Next, a description is given of modification examples of the secondary battery according to an embodiment.

The configuration of the secondary battery is appropriately modifiable as described below. Note that any of the following series of modification examples may be combined with each other.

The separator 23 that is a porous film is used. However, although not specifically illustrated here, a separator of a stacked type may be used.

Specifically, the separator of the stacked type includes a porous film and a polymer compound. The porous film has two opposed surfaces, and the polymer compound layer is provided on one of or each of the two opposed surfaces of the porous film. One reason for this is that this improves adherence of the separator to each of the positive electrode 21 and the negative electrode 22, and thus suppresses winding displacement of the battery device 20. Accordingly, swelling of the secondary battery is suppressed even if the decomposition reaction of the electrolytic solution occurs. The polymer compound layer includes a polymer compound such as polyvinylidene difluoride. Polyvinylidene difluoride is superior in physical strength and is electrochemically stable.

Note that the porous film, the polymer compound layer, or both may each include insulating particles. One reason for this is that, because the insulating particles promote heat dissipation upon heat generation by the secondary battery, this improves safety or heat resistance of the secondary battery. The insulating particles include any one or more of insulating materials including, without limitation, an inorganic material and a resin material. Specific examples of the inorganic material include aluminum oxide, aluminum nitride, boehmite, silicon oxide, titanium oxide, magnesium oxide, and zirconium oxide. Specific examples of the resin material include acrylic resin and styrene resin.

To fabricate the separator of the stacked type, a precursor solution including the polymer compound and a solvent is prepared, following which the precursor solution is applied on one of or each of the two opposed surfaces of the porous film. In this case, insulating particles may be added to the precursor solution on an as-needed basis.

When the separator of the stacked type is used also, lithium is movable in the ionic state between the positive electrode 21 and the negative electrode 22, and similar effects are therefore achievable. In this case, in particular, the secondary battery improves in safety, as described above. Accordingly, it is possible to achieve higher effects.

The electrolytic solution that is a liquid electrolyte is used. However, although not specifically illustrated here, an electrolyte layer that is a gel electrolyte may be used.

In the battery device 20 including the electrolyte layer, the positive electrode 21 and the negative electrode 22 are stacked on each other with the separator 23 and the electrolyte layer interposed therebetween, and the stack of the positive electrode 21, the negative electrode 22, the separator 23, and the electrolyte layer is wound. The electrolyte layer is interposed between the positive electrode 21 and the separator 23, and between the negative electrode 22 and the separator 23.

Specifically, the electrolyte layer includes a polymer compound together with the electrolytic solution. The electrolytic solution is held by the polymer compound. One reason for this is that this prevents leakage of the electrolytic solution. The configuration of the electrolytic solution is as described above. The polymer compound includes, for example, polyvinylidene difluoride. To form the electrolyte layer, a precursor solution including the electrolytic solution, the polymer compound, and a solvent is prepared, following which the precursor solution is applied on one side or both sides of the positive electrode 21 and on one side or both sides of the negative electrode 22.

When the electrolyte layer is used also, lithium is movable in the ionic state between the positive electrode 21 and the negative electrode 22 via the electrolyte layer, and similar effects are therefore achievable. In this case, in particular, the leakage of the electrolytic solution is prevented, as described above. Accordingly, it is possible to achieve higher effects. Lastly, a description is given of applications of the secondary battery.

Applications (application examples) of the secondary battery are not particularly limited. The secondary battery used as a power source may serve as a main power source or an auxiliary power source of, for example, electronic equipment and an electric vehicle. The main power source is preferentially used regardless of the presence of any other power source. The auxiliary power source may be used in place of the main power source, or may be switched from the main power source.

Specific examples of the applications of the secondary battery include: electronic equipment; apparatuses for data storage; electric power tools; battery packs to be mounted on, for example, electronic equipment; medical electronic equipment; electric vehicles; and electric power storage systems. Examples of the electronic equipment include video cameras, digital still cameras, mobile phones, laptop personal computers, headphone stereos, portable radios, and portable information terminals. Examples of the apparatuses for data storage include backup power sources and memory cards. Examples of the electric power tools include electric drills and electric saws. Examples of the medical electronic equipment include pacemakers and hearing aids. Examples of the electric vehicles include electric automobiles including hybrid automobiles. Examples of the electric power storage systems include battery systems for home use or industrial use in which electric power is accumulated for a situation such as emergency. In each of the above-described applications, one secondary battery may be used, or multiple secondary batteries may be used.

The battery packs may each include a battery cell, or may each include an assembled battery. The electric vehicle is a vehicle that travels with the secondary battery as a driving power source, and may be a hybrid automobile that is additionally provided with another driving source other than the secondary battery. In the electric power storage system for home use, electric power accumulated in the secondary battery that is an electric power storage source may be utilized for using, for example, home appliances.

An application example of the secondary battery will now be described in detail. The configuration of the application example described below is merely an example, and is appropriately modifiable.

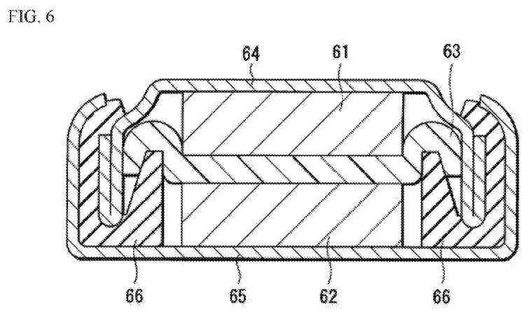

FIG. 5 illustrates a block configuration of a battery pack. The battery pack described here is a battery pack including one secondary battery, is what is called a soft pack, and is to be mounted on, for example, electronic equipment typified by a smartphone.

As illustrated in FIG. 5, the battery pack includes an electric power source 51 and a circuit board 52. The circuit board 52 is coupled to the electric power source 51, and includes a positive electrode terminal 53, a negative electrode terminal 54, and a temperature detection terminal 55.

The electric power source 51 includes one secondary battery. The secondary battery has a positive electrode lead coupled to the positive electrode terminal 53 and a negative electrode lead coupled to the negative electrode terminal 54. The electric power source 51 is couplable to outside via the positive electrode terminal 53 and the negative electrode terminal 54, and is thus chargeable and dischargeable. The circuit board 52 includes a controller 56, a switch 57, a PTC device 58, and a temperature detector 59. However, the PTC device 58 may be omitted.

The controller 56 includes, for example, a central processing unit (CPU) and a memory, and controls an overall operation of the battery pack. The controller 56 detects and controls a use state of the electric power source 51 on an as-needed basis.

If a voltage of the electric power source 51 (the secondary battery) reaches an overcharge detection voltage or an overdischarge detection voltage, the controller 56 turns off the switch 57. This prevents a charging current from flowing into a current path of the electric power source 51. The overcharge detection voltage is not particularly limited, and is specifically 4.20 V±0.05 V. The overdischarge detection voltage is not particularly limited, and is specifically 2.40 V±0.1 V.

The switch 57 includes, for example, a charge control switch, a discharge control switch, a charging diode, and a discharging diode. The switch 57 performs switching between coupling and decoupling between the electric power source 51 and external equipment in accordance with an instruction from the controller 56. The switch 57 includes, for example, a metal-oxide-semiconductor field-effect transistor (MOSFET). Each of the charging current and a discharging current is detected based on an ON-resistance of the switch 57.

The temperature detector 59 includes a temperature detection device such as a thermistor. The temperature detector 59 measures a temperature of the electric power source 51 through the temperature detection terminal 55, and outputs a result of the temperature measurement to the controller 56. The result of the temperature measurement obtained by the temperature detector 59 is used, for example, when the controller 56 performs charge and discharge control upon abnormal heat generation or when the controller 56 performs a correction process upon calculating a remaining capacity.

### EXAMPLES

A description is given of Examples of the present technology according to an embodiment.

### Examples 1 and 2 and Comparative Examples 1 and 2

Secondary batteries were fabricated, following which the secondary batteries were each evaluated for a battery characteristic, as described below.

### <Fabrication of Secondary Battery>

Here, a test secondary battery was fabricated to conduct a simple evaluation for the battery characteristic. FIG. 6 illustrates a sectional configuration of the test secondary battery. The test secondary battery was a secondary battery of what is called a coin type.

In the following, the configuration of the test secondary battery is described, and then a fabrication procedure for the test is described. In this case, the test secondary battery is simply referred to as the “secondary battery” to simplify the description.

As illustrated in FIG. 6, the secondary battery included a test electrode 61, a counter electrode 62, a separator 63, an outer package cup 64, an outer package can 65, a gasket 66, and an electrolytic solution (not illustrated).

The test electrode 61 was placed in the outer package cup 64, and the counter electrode 62 was placed in the outer package can 65. The test electrode 61 and the counter electrode 62 were stacked on each other with the separator 63 interposed therebetween. The test electrode 61, the counter electrode 62, and the separator 63 were each impregnated with the electrolytic solution. The outer package cup 64 and the outer package can 65 were crimped to each other with the gasket 66 interposed therebetween. Thus, the test electrode 61, the counter electrode 62, and the separator 63 were sealed in the outer package cup 64 and the outer package can 65.

### <Fabrication of Test Electrode>

First, 94 parts by mass of a negative electrode active material (4 parts by mass of silicon oxide as a metal-based material and 90 parts by mass of artificial graphite as a carbon material), 1.5 parts by mass of a negative electrode binder (polyvinylidene difluoride), 2.5 parts by mass of a negative electrode conductor (2 parts by mass of carbon nanotubes and 0.5 parts by mass of graphite), and 2 parts by mass of a thickener (carboxymethyl cellulose) were mixed with each other to thereby form a negative electrode mixture.

Thereafter, the negative electrode mixture was put into a solvent (pure water as an aqueous solvent), following which the solvent was stirred to thereby prepare a negative electrode mixture slurry in paste form.

Thereafter, the negative electrode mixture slurry was applied on one of the two opposed surfaces of the negative electrode current collector (a copper foil having a thickness of 8 μm) using a coating apparatus, following which the applied negative electrode mixture slurry was dried to thereby form the negative electrode active material layer.

Thereafter, the fluorine compound was put into a solvent (dimethyl carbonate), following which the solvent was stirred to thereby prepare a coating solution. As the fluorine compound, hexafluoroisopropoxide ((CF₃)₂HCOLi (LiHFIP)) was used.

Thereafter, the coating solution was applied on the surface of the negative electrode active material layer using the coating apparatus, following which the applied coating solution was dried to thereby form the negative electrode film including the fluorine compound.

Lastly, the negative electrode active material layer and the negative electrode film were compression-molded using the roll pressing machine, following which the negative electrode current collector on which the negative electrode active material layer and the negative electrode film were formed was cut into a circular plate shape. The test electrode 61 was thus fabricated (Examples 1 and 2).

Note that the test electrode 61 for comparison (Comparative example 1) was fabricated by a similar procedure except that no negative electrode film was formed.

### <Fabrication of Counter Electrode>

First, 91 parts by mass of a positive electrode active material (LiNi_{0.80}Co_{0.15}Al_{0.05}O₂ as a lithium-containing compound (an oxide)), 3 parts by mass of a positive electrode binder (polyvinylidene difluoride), and 6 parts by mass of a positive electrode conductor (Ketjen black as amorphous carbon powder) were mixed with each other to thereby obtain a positive electrode mixture. Thereafter, the positive electrode mixture was put into a solvent (N-methyl-2-pyrrolidone as an organic solvent), following which the solvent was stirred to thereby prepare a positive electrode mixture slurry in paste form.

Thereafter, the positive electrode mixture slurry was applied on one of the two opposed surfaces of the positive electrode current collector (an aluminum foil having a thickness of 10 μm) using the coating apparatus, following which the applied positive electrode mixture slurry was dried to thereby form the positive electrode active material layer.

Lastly, the positive electrode active material layer was compression-molded using the roll pressing machine, following which the positive electrode current collector on which the positive electrode active material layer was formed was cut into a circular plate shape. The counter electrode 62 was thus fabricated.

### <Preparation of Electrolytic Solution>

First, a solvent was prepared. Used as the solvent was a mixture of ethylene carbonate as a cyclic carbonic acid ester and dimethyl carbonate as a chain carbonic acid ester. In this case, a mixture ratio (a weight ratio) of the solvent was set as follows: cyclic carbonic acid ester: chain carbonic acid ester=30:70.

Thereafter, an electrolyte salt (lithium hexafluorophosphate as a lithium salt) was added to the solvent, following which the solvent was stirred. In this case, a content of the electrolyte salt was 1 mol/kg with respect to the solvent.

Lastly, a nitrile compound (succinonitrile (SN)) was added to the solvent on an as-needed basis, following which the solvent was stirred. In this case, a content of the nitrile compound in the electrolytic solution was set to 1 wt %. The electrolytic solution was thus prepared.

Note that an electrolytic solution for comparison (Comparative example 2) was prepared by a similar procedure, except that alcohol (isopropanol (IPA)) was added to the electrolytic solution instead of forming the negative electrode film. In this case, the test electrode 61 including no negative electrode film was fabricated.

### <Assembly of Secondary Battery>

First, the test electrode 61 was placed in the outer package cup 64, and the counter electrode 62 was placed in the outer package can 65. Thereafter, the test electrode 61 placed in the outer package cup 64 and the counter electrode 62 placed in the outer package can 65 were stacked on each other with the separator 63 (a fine porous polyethylene film having a thickness of 20 μm), which had been impregnated with the electrolytic solution, interposed therebetween. In this case, the positive electrode active material layer and the negative electrode active material layer were opposed to each other with the separator 63 interposed therebetween.

Lastly, the outer package cup 64 and the outer package can 65 were crimped to each other with the gasket 66 interposed therebetween, in a state where the test electrode 61 and the counter electrode 62 were stacked on each other with the separator 63 interposed therebetween. Accordingly, the test electrode 61 and the counter electrode 62 were sealed in the outer package cup 64 and the outer package can 65. As a result, the secondary battery was assembled.

### <Process of Stabilizing Assembled Secondary Battery>

The secondary battery was charged and discharged for one cycle in an ambient temperature environment (at a temperature of 23° C.). Upon charging, the secondary battery was charged with a constant current of 0.1 C until a voltage reached 4.2 V, and was thereafter charged with a constant voltage of that value, 4.2 V, until a current reached 0.025 C. Upon discharging, the secondary battery was discharged with a constant current of 0.1 C until the voltage reached 2.5 V. Note that 0.1 C was a value of a current that caused a battery capacity (a theoretical capacity) to be completely discharged in 10 hours, and 0.025 C was a value of a current that caused the battery capacity to be completely discharged in 40 hours.

The battery device 20 was thus brought into an electrochemically stable state. As a result, the secondary battery was completed.

### <Evaluation of Battery Characteristic>

Results of the analysis of the surface (the negative electrode film) of the test electrode 61 by the ¹⁹F NMR were as presented in Table 1.

In the “¹⁹F NMR analysis results” column in Table 1, the following contents are presented. The “peak P” column indicates whether the peak P was detected within the range of the chemical shift from −90 ppm to −70 ppm both inclusive. The “number” column indicates the number of the peaks P. The “coupling constant (Hz)” column indicates the coupling constant (Hz).

Here, the secondary batteries were each evaluated for a cyclability characteristic as the battery characteristic in accordance with the following procedure, and the evaluation revealed the results presented in Table 1.

To evaluate the cyclability characteristic, first, the secondary battery was charged and discharged in an ambient temperature environment to thereby measure a discharge capacity (a first-cycle discharge capacity).

Thereafter, the secondary battery was repeatedly charged and discharged in the same environment until the total number of cycles reached 150 to thereby measure the discharge capacity (a 150th-cycle discharge capacity).

Charging and discharging conditions in the first cycle to the 150th-cycle were set to be similar to the charging and discharging conditions for the process of stabilizing the assembled secondary battery described above.

Lastly, a capacity retention rate serving as an index for evaluating the cyclability characteristic was calculated based on the following calculation expression: capacity retention rate (%)=(150th-cycle discharge capacity/first-cycle discharge capacity)×100.

TABLE 1

| | Negative | | | | | | |
|---|---|---|---|---|---|---|---|
| | electrode | | | ¹⁹F NMR analysis results | | | Capacity |
| | film | Electrolytic solution | | | | Coupling | retention |
| | Fluorine | | Nitrile | | | constant | rate |
| | compound | Alcohol | compound | Peak P | Number | (Hz) | (%) |
| Example 1 | LiHFIP | — | — | Detected | 2 | 7.06 | 68 |
| Example 2 | LiHFIP | — | SN | Detected | 2 | 7.06 | 70 |
| Comparative | — | — | — | Not | — | — | 60 |
| example 1 | | | | detected | | | |
| Comparative | — | IPA | — | Not | — | — | 55 |
| example 2 | | | | detected | | | |

As indicated in Table 1, the capacity retention rate varied greatly depending on the physical properties of the negative electrode film.

Specifically, when the negative electrode film including the fluorine compound was not provided on the surface of the negative electrode active material layer (Comparative example 1), no peak P was detected based on the analysis of the negative electrode film by the ¹⁹F NMR. Therefore, the two physical property conditions were not satisfied regarding the physical properties of the negative electrode film. This resulted in a decrease in the capacity retention rate.

Further, when the negative electrode film including the fluorine compound was not provided on the surface of the negative electrode active material layer but the electrolytic solution included alcohol (Comparative example 2), the two physical property conditions were not satisfied regarding the physical properties of the negative electrode film either. This resulted in a decrease in the capacity retention rate.

In contrast, when the negative electrode film including the fluorine compound was provided on the surface of the negative electrode active material layer (Example 1), the peaks P were detected based on the analysis of the negative electrode film by the ¹⁹F NMR. Therefore, the two physical property conditions were satisfied regarding the physical properties of the negative electrode film. Specifically, two peaks P were detected, and the coupling constant was within a range of 50 Hz or less. This resulted in an increase in the capacity retention rate.

In this case, in particular, when the electrolytic solution included the nitrile compound (Example 2), the capacity retention rate further increased.

Based on the results indicated in Table 1, when the negative electrode film including the fluorine compound was provided on the surface of the negative electrode active material layer, and the two physical property conditions were satisfied regarding the physical properties of the negative electrode film, the cyclability characteristic improved, and a superior battery characteristic was thus obtained.

Although the present technology has been described above with reference to one or more embodiments including Examples, the configuration of the present technology is not limited thereto, and is therefore modifiable in a variety of ways.

For example, the description has been given of the case where the secondary battery has a battery structure of the laminated-film type or the coin type; however, the battery structure of the secondary battery of the present technology is not particularly limited. Specifically, the battery structure of the secondary battery may be, for example, of a cylindrical type or a prismatic type.

Further, the description has been given of the case where the battery device has a device structure of a wound type. However, the device structure of the battery device is not particularly limited, and may be, for example, of a stacked type or a zigzag folded type. In the stacked type, the positive electrode and the negative electrode are alternately stacked on each other with the separator interposed therebetween. In the zigzag folded type, the positive electrode and the negative electrode are opposed to each other with the separator interposed therebetween, and are folded in a zigzag manner.

The effects described herein are mere examples, and effects of the present technology are therefore not limited to those described herein. Accordingly, the present technology may achieve any other effect.

Note that the present technology may have any of the following configurations according to an embodiment.

<1>

A secondary battery including:
a positive electrode;
a negative electrode; and
an electrolytic solution, in which
the negative electrode includes
   a negative electrode active material layer, and
   a negative electrode film provided on a surface of the negative electrode active material layer,
the negative electrode film includes a fluorine compound including a carbon-fluorine bond,
based on an analysis of the negative electrode film by fluorine-19 nuclear magnetic resonance spectroscopy, two or more peaks are detectable within a range of a chemical shift of greater than or equal to −90 parts per million and less than or equal to −70 parts per million, and
a coupling constant associated with the two or more peaks is 50 hertz or less.
   <2>

The secondary battery according to <1>, in which the negative electrode film includes a fluorinated alkoxide represented by Formula (1):

$$R 1 R 2 R 3 COLi \qquad ( 1 )$$

where
each of R1, R2, and R3 is one of a hydrogen group, an alkyl group, or a fluorinated alkyl group, and
at least one of R1, R2, or R3 is the fluorinated alkyl group.
   <3>

The secondary battery according to <2>, in which two of R1, R2, or R3 are each the fluorinated alkyl group.

<4>

The secondary battery according to <2> or <3>, in which the fluorinated alkoxide has carbon number of greater than or equal to 3 and less than or equal to 5.

<5>

The secondary battery according to any one of <1> to <4>, in which the electrolytic solution includes a nitrile compound.

<6>

The secondary battery according to any one of <1> to <5>, in which the secondary battery includes a lithium secondary battery.

### REFERENCE SIGNS LIST

21 Positive electrode
22 Negative electrode
22B Negative electrode active material layer
22C Negative electrode film
P Peak

It should be understood that various changes and modifications to the embodiments described herein will be apparent to those skilled in the art. Such changes and modifications can be made without departing from the spirit and scope of the present subject matter and without diminishing its intended advantages. It is therefore intended that such changes and modifications be covered by the appended claims.

1. A secondary battery comprising:
a positive electrode;
a negative electrode; and
an electrolytic solution, wherein
the negative electrode includes
a negative electrode active material layer, and
a negative electrode film provided on a surface of the negative electrode active material layer,
the negative electrode film includes a fluorine compound including a carbon-fluorine bond,
based on an analysis of the negative electrode film by fluorine-19 nuclear magnetic resonance spectroscopy, two or more peaks are detectable within a range of a chemical shift of greater than or equal to −90 parts per million and less than or equal to −70 parts per million, and
a coupling constant associated with the two or more peaks is 50 hertz or less.

2. The secondary battery according to claim 1, wherein the negative electrode film includes a fluorinated alkoxide represented by Formula (1):
$$R 1 R 2 R 3 COLi \qquad ( 1 )$$
where
each of R1, R2, and R3 is one of a hydrogen group, an alkyl group, or a fluorinated alkyl group, and
at least one of R1, R2, or R3 is the fluorinated alkyl group.

3. The secondary battery according to claim 2, wherein two of R1, R2, or R3 are each the fluorinated alkyl group.

4. The secondary battery according to claim 2, wherein the fluorinated alkoxide has carbon number of greater than or equal to 3 and less than or equal to 5.

5. The secondary battery according to claim 1, wherein the electrolytic solution includes a nitrile compound.

6. The secondary battery according to claim 1, wherein the secondary battery comprises a lithium secondary battery.
